(19) United States
(12) Patent Application Publication
(10) Pub. No.: US 2006/0029819 A1
(43) Pub. Date: Feb. 9, 2006

(54) Laminate for flexible printed circuit board comprising tie layer of ternary copper alloy

(76) Inventor: Jeong Cho, Yongin-Shi (KR)

Correspondence Address: DITTHAVONG & CARLSON, P.C., Suite A, 10507 Braddock Road, Fairfax, VA, 22032, US

(21) Appl. No.: 11/194,916

(22) Filed: Aug. 1, 2005

(30) Foreign Application Priority Data
Aug. 2, 2004 (KR) 2004-60910

(51) Int. Cl. B32B 15/08

(52) U.S. Cl. 428/458; 428/674

(57) ABSTRACT

Disclosed herein is a laminate for a flexible printed circuit board, which includes a base film, and a tie layer formed of a copper alloy containing a small amount of Zn—V or Zn—Ta disposed on the base film. As such, the tie layer formed of a copper alloy containing Zn—V has a component ratio of Zn in the copper alloy larger than that of V, and preferably, includes more than 2.5% Zn but not more than 5%, and less than 2.5% V. In addition, the tie layer formed of a copper alloy containing Zn—Ta has a component ratio of Zn in the copper alloy larger than that of Ta, and preferably, includes more than 2.5% Zn but not more than 5%, and less than 2.5% Ta.

### BACKGROUND OF THE INVENTION

1. Field of the Invention

The present invention relates, generally, to a flexible printed circuit board (FPCB) for use in electronic products, and, more particularly, to a laminate for an FPCB, which comprises a tie layer functioning to prevent copper from being diffused into a polyimide film upon vacuum sputtering of copper and increase adhesive strength between copper and a polyimide film, chemical resistance and heat resistance.

2. Description of the Related Art

In general, a conventional FPCB includes a substrate composed of a polyimide film and a copper foil bonded together using an adhesive. The method of manufacturing such an FPCB comprises separately preparing a copper foil and a polyimide film, wet coating a modified epoxy type adhesive on the polyimide film and drying it, and laminating the copper foil on the polyimide film to a thickness of about 10-15 μm using a heated roll shaped laminator to prepare a substrate, which then undergoes aging, thereby completing a desired FPCB.

However, as electronic products, in particular, display devices, such as mobile phones and LCDs, require miniaturization and high performance, the substrate for an FPCB manufactured by use of the adhesive has the following problems. That is, with the goal of formation of a high density circuit pattern to achieve miniaturization and high performance of devices, a heating process and a wet chemical treating process (etching, plating, developing, soldering, etc.) should be conducted. As such, however, dimensional stability of the substrate is worsened due to the difference in thermal expansion coefficient between the adhesive and the copper foil and between the adhesive and the polyimide film. In addition, through the chemical treatment, the adhesive strength is weakened, and moisture absorption resistance of the polyimide film is decreased, therefore increasing the defect rates of the substrate.

To solve the problems related to the quality of the substrate due to the use of the adhesive, research into methods of manufacturing a two-layered substrate for an FPCB including a copper foil and a polyimide film bonded together without the use of an adhesive has been vigorously conducted. Presently, the methods of manufacturing a two-layered substrate for an FPCB may be largely divided into casting and plating techniques. In the casting technique, a polyimide varnish is applied on a copper foil, dried, cured and then processed into a film. The plating technique includes surface treating a polyimide film to increase adhesive strength, coating the surface treated polyimide film with copper to a thickness of sub-μm in a vacuum, and then conducting electrical plating using the copper layer as a conductive layer, thereby forming a copper plated layer having a thickness from 1 to 12 μm.

Particularly, in the plating technique, a process of coating the upper surface of the polyimide film with a tie layer in a vacuum is used, so that copper is prevented from being diffused into the polyimide film upon application in a vacuum and the adhesive strength between the copper foil and the polyimide film is increased. Such a tie layer is formed of Cr, monel (Ni—Cu), Ni—Cr, etc.

Moreover, while electronic products are fabricated to be further miniaturized and have higher performance, and in particular, display devices, such as mobile phones and LCDs, are required to have a more complicated and denser structure and exhibit high performance, the number of driver ICs functioning to drive devices and their degree of integration have been further increased. Accordingly, the pattern width of a circuit is decreasing to pitches of 100-120 μm from conventional pitches of 150-200 μm, and, in the future, pitches of 100 μm or less are expected to be required for a high density circuit pattern.

However, the tie layer, which is formed of Cr, monel (Ni—Cu), Ni—Cr, etc., cannot sufficiently exhibit adhesive strength, chemical resistance, and heat resistance at high temperatures, required for a high density circuit pattern. Thus, there is the need for a laminate for an FPCB having higher adhesive strength, chemical resistance and heat resistance at high temperatures required for a high density circuit pattern in the future.

### SUMMARY OF THE INVENTION

Accordingly, the present invention has been made keeping in mind the above problems occurring in the prior art, and an object of the present invention is to provide a laminate for an FPCB, which has excellent adhesive strength, chemical resistance and heat resistance to form a high density circuit pattern required for an FPCB to be miniaturized and have high performance.

Another object of the present invention is to provide a laminate for an FPCB, which has low circuit defect rates, despite many windings being formed on the FPCB, and high reliability.

A further object of the present invention is to provide a laminate for an FPCB, which is suitable for use in a circuit substrate which is normally operated without malfunction under stringent operation conditions of high accuracy and high frequencies.

In order to accomplish the above objects, the present invention provides a laminate for a flexible printed circuit board, comprising a base film and a tie layer formed of a copper alloy containing a small amount of Zn—V or Zn—Ta disposed on the base film.

As such, the tie layer formed of a copper alloy containing Zn—V may have a component ratio of Zn in the copper alloy larger than that of V, and preferably, may comprise more than 2.5% Zn but not more than 5%, and less than 2.5% V.

In addition, the tie layer formed of a copper alloy containing Zn—Ta may have a component ratio of Zn in the copper alloy larger than that of Ta, and preferably, may comprise more than 2.5% Zn but not more than 5%, and less than 2.5% Ta.

Thereby, high adhesive strength, chemical resistance and heat resistance may be exhibited to form a high density current pattern required for FPCBs to be miniaturized and have high performance. Moreover, circuit defect rates due to many windings being formed on FPCBs may be decreased, and thus, highly reliable FPCBs may be manufactured.

In addition, the base film may be a polyimide film.

In addition, the tie layer may be formed by sputtering.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a laminate for an FPCB having a tie layer formed on a polyimide film, according to the present invention;

FIG. 2 is a view showing an apparatus for manufacturing a laminate for an FPCB, according to the present invention;

FIG. 3 is a graph showing variation in adhesive strength depending on the component ratio of Zn and V in a copper alloy (copper alloy tie 1: referred to as ‘CAT1’) containing Zn—V, according to the present invention;

FIG. 4 is a graph showing variation in adhesive strength depending on the component ratio of Zn and Ta in a copper alloy (copper alloy tie 2: referred to as ‘CAT2’) containing Zn—Ta, according to the present invention;

FIG. 5 is a graph showing the adhesive strength between the polyimide film and the copper plated layer in each of a laminate for an FPCB having no tie layer and laminates for FPCBs having tie layers formed of different materials upon heat treatment at 150° C. for 168 hr; and

FIGS. 6a and 6b are photographs showing the crystal particles of a conventional laminate for an FPCB having a tie layer and of the laminate for an FPCB having a tie layer of the present invention, respectively, and FIG. 6c and 6d are histograms showing the size distribution of crystal particles of the conventional laminate for an FPCB having a tie layer and of the laminate for an FPCB having a tie layer of the present invention, respectively.

### DESCRIPTION OF THE PREFERRED EMBODIMENTS

Hereinafter, a detailed description will be given of the present invention, with reference to the appended drawings.

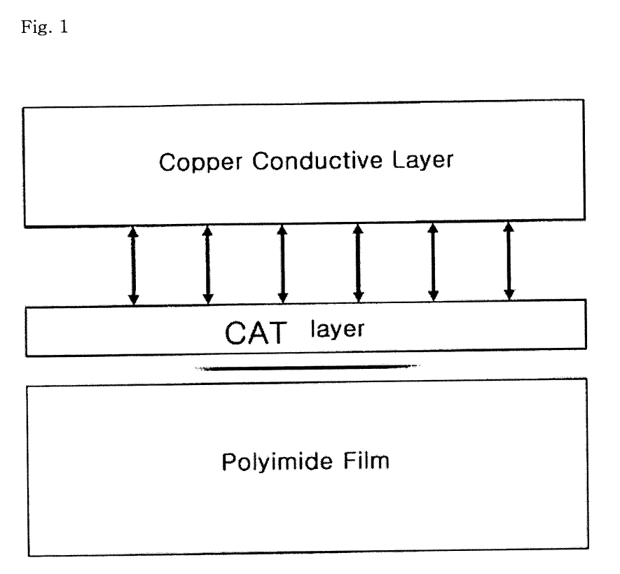

FIG. 1 is a sectional view showing a laminate for an FPCB having a tie layer formed on a polyimide film, according to the present invention. In the present invention, the tie layer is formed of a ternary copper alloy containing Zn—V or Zn—Ta. Below, a ternary copper alloy containing Zn—V is referred to as ‘CAT1’, and a ternary copper alloy containing Zn—Ta is referred to as ‘CAT2’. In FIG. 1, a CAT layer means a layer including any one of ‘CAT1’ and ‘CAT2’.

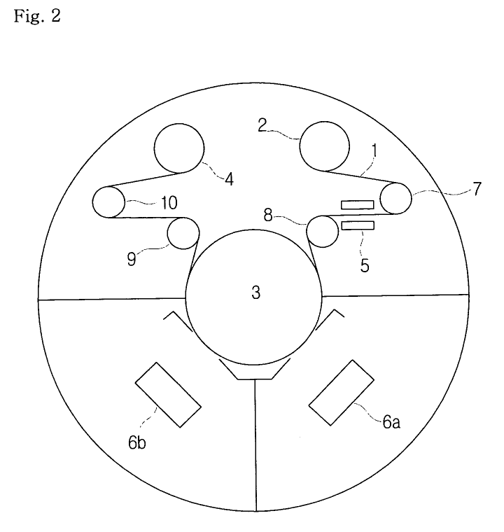

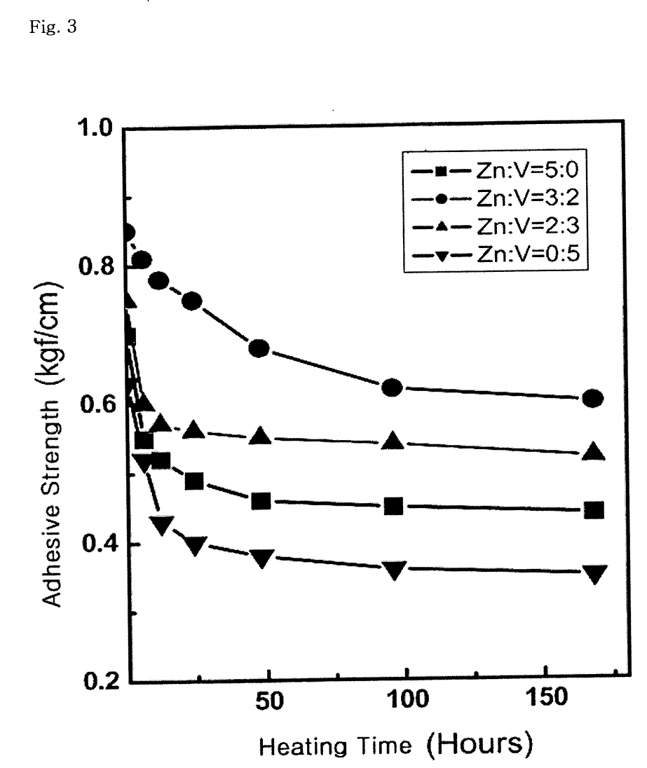

Referring to FIG. 2, a method of manufacturing the laminate for an FPCB shown in FIG. 1 is described. FIG. 2 is a schematic view showing an apparatus for manufacturing a laminate for an FPCB, according to the present invention.

The apparatus for manufacturing a laminate for an FPCB comprises a transferring system including an unwinding roller 2, a main drum 3, and a winding roller 4, all of which are provided in a vacuum chamber. In addition, an infrared heater 5 for pre-heating a polyimide film 1 and film guide rollers 7, 8, 9 and 10 are provided. In addition, a tie layer sputtering cathode 6a and a copper conductive layer sputtering cathode 6b are provided, so that a tie layer and a copper conductive layer are sequentially formed when the polyimide film 1 is in contact with the main drum 3.

In the manufacturing method using the apparatus for manufacturing a laminate for an FPCB, the polyimide film 1 is unwound from the unwinding roller 2 at a predetermined unwinding tension. Then, the polyimide film 1 is heated using the infrared heater 5 between the film guide rollers 7 and 8. The heated polyimide film 1 is guided around the roller 8. While the polyimide film 1 is in contact with the main drum 3, a tie layer formed of a ternary copper alloy of the present invention is first formed by the tie layer sputtering cathode 6a, after which a copper conductive layer is formed by the copper conductive layer sputtering cathode 6b. Thereafter, the polyimide film 1 is guided around the rollers 9 and 10, and then wound on the winding roller 4 at a predetermined winding tension.

Subsequently, the polyimide film 1 undergoes electrical plating using the copper conductive layer to form a copper plated layer thereon, which is not shown in the drawing.

In the present invention, the tie layer is formed through sputtering, but is not limited thereto. The tie layer may be formed through other processes, such as deposition.

Moreover, before the tie layer is formed on the polyimide film, the polyimide film may be surface treated to further increase the adhesive strength, as shown in FIG. 1.

In this way, the copper alloy of the present invention, that is, the ternary copper alloy containing a small amount of Zn—V or Zn—Ta, may be formed into the tie layer.

In the copper alloy containing Zn—V, that is, CAT1, the adhesive strength varies with the component ratio of Zn and V, which is shown in FIG. 3. FIG. 3 is a graph showing the variation in adhesive strength depending on the component ratio of Zn and V in CAT1, in which the axis of abscissa indicates a heating time and the axis of ordinate indicates adhesive strength (kgf/cm) of the laminate for an FPCB of the present invention treated for the above heating time. It is noted that copper (Cu) is uniformly contained in an amount of 95%.

The experiment for measurement of the adhesive strength was performed in such a manner that the laminate for an FPCB having a tie layer of CAT1 is heat treated at 150° C. for 1-168 hr, after which the adhesive strength between the polyimide film and the copper plated layer is measured.

As shown in FIG. 3, when the component ratio of V is increased from 0, the adhesive strength is increased. In addition, when the component ratio of Zn and V is 3:2, the highest adhesive strength is exhibited. Then, if the component ratio of V is higher than the above value, the adhesive strength is decreased. According to the experimental results, when the component ratio of Zn is larger than that of V, the high adhesive strength is obtained. Preferably, the highest adhesive strength is obtained at a component ratio of Zn and V of 3:2.

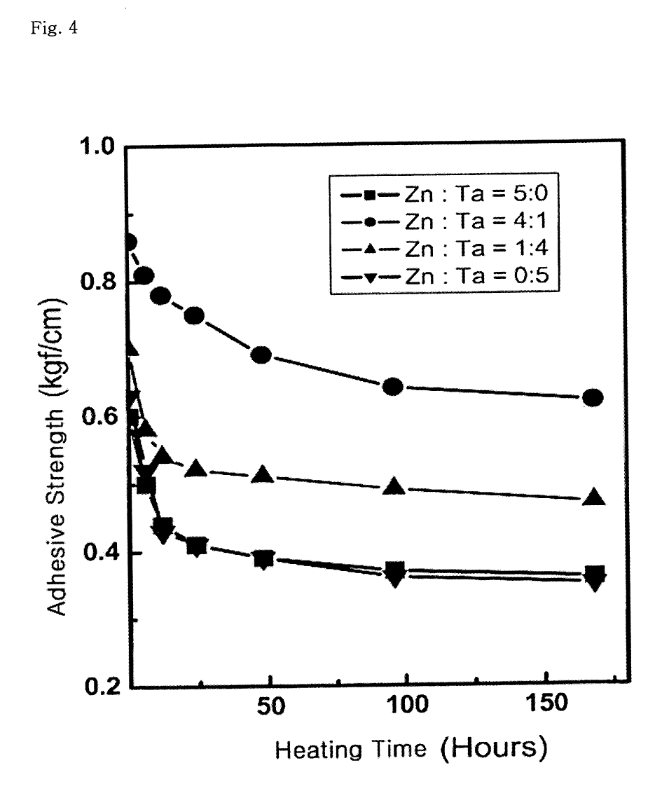

In addition, in the copper alloy containing Zn—Ta, that is, CAT2, the adhesive strength varies with the component ratio of Zn and Ta, which is shown in FIG. 4. FIG. 4 is a graph showing the variation in adhesive strength depending on the component ratio of Zn and Ta in CAT2, in which the axis of abscissa designates a heating time and the axis of ordinate designates adhesive strength (kgf/cm) of the laminate for an FPCB of the present invention treated for the above heating time. It is noted that copper (Cu) is uniformly contained in an amount of 95%, as in the experiment of FIG. 3.

As in the experiment for adhesive strength to the tie layer of CAT1, to measure the adhesive strength, the experiment was carried out in such a manner that the laminate for an FPCB having a tie layer formed of CAT2 is heat treated at 150° C. for 1-168 hr, after which the adhesive strength between the polyimide film and the copper plated layer is measured.

As shown in FIG. 4, an increase in the component ratio of Ta starting from 0 results in high adhesive strength. When the component ratio of Zn and Ta is 4:1, the highest adhesive strength is exhibited. In addition, if the component ratio of Ta is higher than the above value, the adhesive strength is decreased. According to the experimental results, it can be seen that high adhesive strength is obtained when the component ratio of Zn is larger than that of Ta. Preferably, when the component ratio of Zn and Ta is 4:1, the highest adhesive strength is manifested.

A laminate (Cu/PI) for an FPCB having no tie layer, conventional laminates (Cu/monel/PI and Cu/Ni—Cr/PI) for an FPCB using monel (Ni—Cu) and Ni—Cr as a tie layer, and laminates (Cu/CAT1/PI and Cu/CAT2/PI) for an FPCB using ternary copper alloys of CAT1 and CAT2 as a tie layer of the present invention are compared in adhesive strength, heat resistance and chemical resistance.

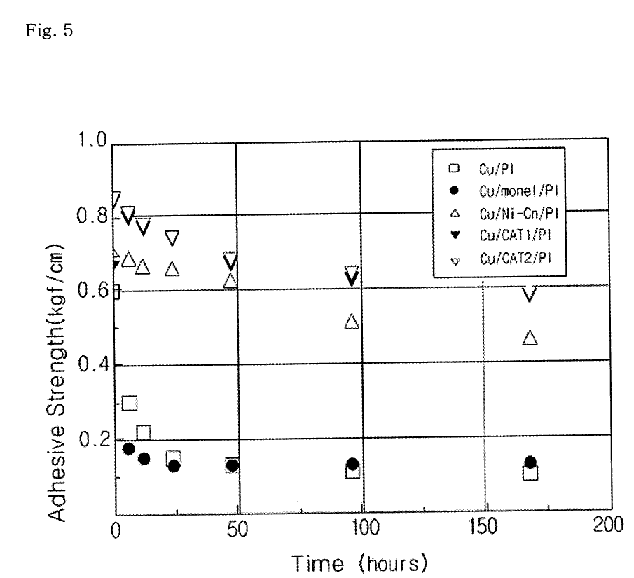

FIG. 5 is a graph showing the adhesive strength between the polyimide film and the copper plated layer in each of the laminate having no tie layer and laminates having tie layers formed of different materials, upon heat treatment at 150° C. for a predetermined time, in which the axis of abscissa designates a heating time and the axis of ordinate designates the adhesive strength (kgf/cm) of the laminate for an FPCB of the present invention treated for the heating time.

As shown in FIG. 5, the laminate for an FPCB having a tie layer of the present invention has initial adhesive strength, that is, Cu/CAT1/PI=0.85 kgf/cm or Cu/CAT2/PI=0.86 kgf/cm, which is higher than the adhesive strength of the conventional laminate for an FPCB having a tie layer formed of a different material, that is, Cu/monel/PI=0.62 kgf/cm or Cu/Ni—Cr/PI=0.7 kgf/cm.

In addition, after each laminate for an FPCB is heat treated for 150 hr or longer, the laminate for an FPCB having a tie layer of the present invention has adhesive strength, that is, Cu/CAT1/PI=0.59 kgf/cm or Cu/CAT2/PI=0.6 kgf/cm, which is higher than the adhesive strength of the conventional laminate for an FPCB having a tie layer formed of a different material, that is, Cu/monel/PI=0.12 kgf/cm or Cu/Ni—Cr/PI=0.45 kgf/cm.

Hence, the laminate for an FPCB having a tie layer of the present invention is confirmed to have adhesive strength and hest resistance superior to a conventional laminate for an FPCB.

In addition, laminates for FPCBs using different materials for the tie layers are measured for chemical resistance. The results are given in Table 1, below.

TABLE 1

| | | Adhesive Strength After Chemical | |
|---|---|---|---|
| | Initial Adhesive | Resistance Treatment (kgf/cm) | |
| | Strength (kgf/cm) | Base Resistance | Acid Resistance |
| Cu/PI | 0.6 | 0.1 | 0.1 |
| Cu/monel/PI | 0.62 | 0.4 | 0.37 |
| Cu/Ni-Cr/PI | 0.7 | 0.65 | 0.63 |
| CAT1 | 0.85 | 0.81 | 0.8 |
| CAT2 | 0.86 | 0.81 | 0.8 |

To measure chemical resistance, a base resistance test was performed in such a manner that each laminate for an FPCB is dipped into 8% NaOH for 5 min, and then the adhesive strength between the copper plated layer and the polyimide film is measured. In addition, an acid resistance test was performed in such a manner that each laminate for an FPCB is dipped into 8% HCl for 5 min, and then the adhesive strength between the copper plated layer and the polyimide film is measured.

As is apparent from Table 1, after the base resistance test, the laminate for an FPCB having a tie layer of the present invention has adhesive strength, that is, Cu/CAT1/PI=0.81 kgf/cm or Cu/CAT2/PI=0.81 kgf/cm, which is higher than the adhesive strength of the conventional laminate for an FPCB having a tie layer formed of a different material, that is, Cu/monel/PI=0.4 kgf/cm or Cu/Ni—Cr/PI=0.65 kgf/cm.

After the acid resistance test, the laminate for an FPCB having a tie layer of the present invention has adhesive strength, that is, Cu/CAT1/PI 0.8 kgf/cm or Cu/CAT2/PI=0.8 kgf/cm, which is higher than the adhesive strength of the conventional laminate for an FPCB having a tie layer formed of a different material, that is, Cu/monel/PI=0.37 kgf/cm or Cu/Ni—Cr/PI=0.63 kgf/cm.

From the results of the chemical resistance test, it can be seen that the laminate for an FPCB having a tie layer of the present invention has chemical resistance including base resistance and acid resistance superior to a conventional laminate for an FPCB.

In addition, each laminate for an FPCB undergoes gold plating as terminal plating for soldering to mount parts, after which adhesive strength is measured. The results are given in Table 2, below.

TABLE 2

| | Initial Adhesive | Adhesive Strength After |
|---|---|---|
| | Strength (kgf/cm) | Treatment (kgf/cm) |
| Cu/PI | 0.6 | 0.1 |
| Cu/monel/PI | 0.62 | 0.45 |
| Cu/Ni-Cr/PI | 0.7 | 0.65 |
| CAT1 | 0.85 | 0.81 |
| CAT2 | 0.86 | 0.82 |

In order to apply the laminate for an FPCB to electronic products, adhesive strength after chemical plating must be 90% or more of initial adhesive strength.

As is apparent from Table 2, the laminate for FPCB having a tie layer of the present invention has adhesive strength after plating, that is, Cu/CAT1/PI=0.81 kgf/cm or Cu/CAT2/PI=0.82 kgf/cm, which is higher than 90% of initial adhesive strength, regarded as an acceptable standard, and the adhesive strength of the conventional laminate for an FPCB having a tie layer formed of a different material, that is, Cu/monel/PI 0.45 kgf/cm or Cu/Ni—Cr/PI=0.65 kgf/cm.

Therefore, it can be seen that the laminate for an FPCB having a tie layer of the present invention has adhesive strength after gold plating that is superior to a conventional laminate for an FPCB having a tie layer formed of a different material.

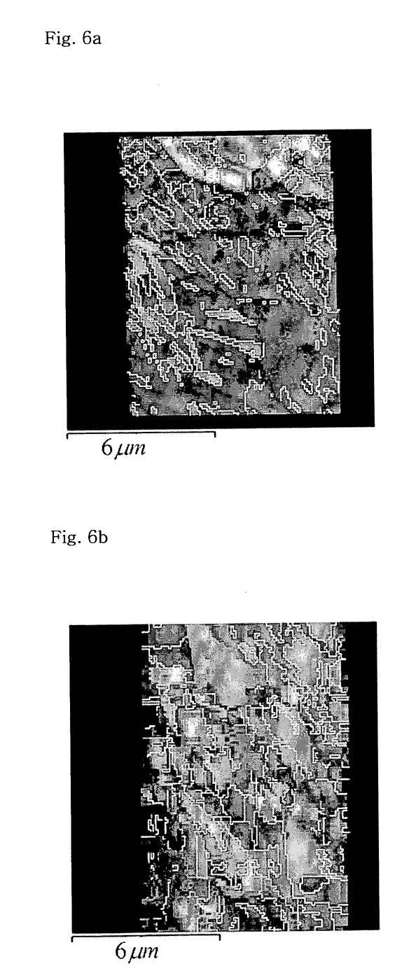

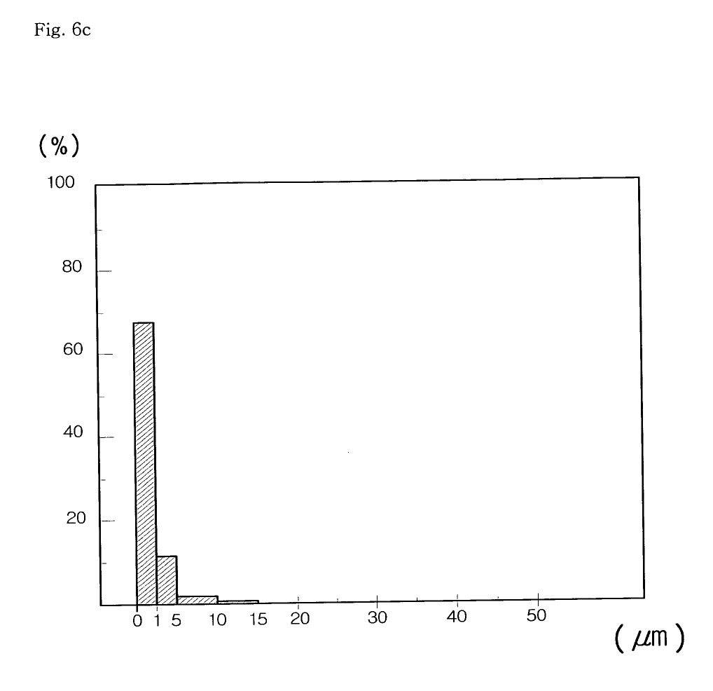

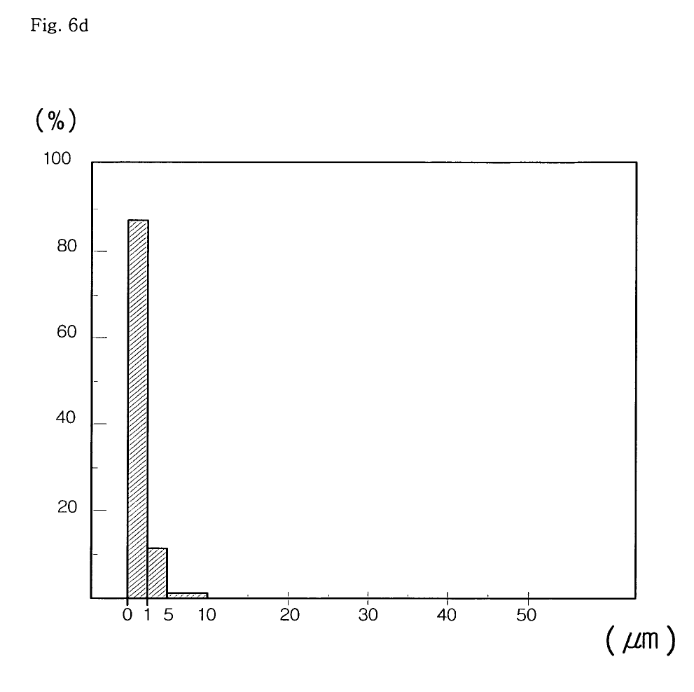

FIGS. 6a to 6d show the sizes of crystal particles of the conventional laminate for an FPCB having a tie layer formed of Ni—Cr, and of the laminate for an FPCB having a tie layer formed of a copper alloy containing Zn—V of the present invention.

Specifically, FIG. 6a is a photograph showing the crystal particles of the conventional laminate for an FPCB having a tie layer formed of Ni—Cr, and FIG. 6b is a photograph showing the crystal particles of the laminate for an FPCB having a tie layer formed of a copper alloy containing Zn—V of the present invention. In addition, FIG. 6c is a histogram showing the size distribution of crystal particles of the conventional laminate for an FPCB having a tie layer formed of Ni—Cr, and FIG. 6d is a histogram showing the size distribution of crystal particles of the laminate for an FPCB having a tie layer formed of a copper alloy containing Zn—V of the present invention. As such, the axis of abscissa indicates the size of the crystal particles, and the axis of ordinate indicates the distribution rate.

As shown in FIG. 6d, 1 μm or less sized crystal particles of the laminate for an FPCB having a tie layer of the present invention constitute 85% or more thereof, whereas 1 μm or less sized crystal particles of the conventional laminate for an FPCB having an Ni—Cr tie layer constitute about 65% thereof.

In the laminate for an FPCB, the smaller the crystal particle size, the higher the formation rate of the particles acting to absorb and retard the propagation of cracks, thus reducing the crack propagation rate of the substrate. Thereby, short circuit and wire breakage caused by fatigue of metal due to many windings formed on the FPCB are not generated in a short time, resulting in decreased defect rates. Consequently, the reliability of the FPCB is increased.

Hence, the FPCB having a tie layer of the present invention has higher reliability than the conventional FPCB having a tie layer of Ni—Cr.

In this way, the laminate for an FPCB having a tie layer of the present invention may be applied to all fields of electronic products, for example, FPCBs, and circuit substrates, such as TAB, COF and BGA.

As described above, the present invention provides a laminate for an FPCB comprising a tie layer of a ternary copper alloy. According to the present invention, the laminate for an FPCB includes a tie layer formed of a ternary copper alloy containing Zn—V or Zn—Ta, and thus, high adhesive strength, chemical resistance and heat resistance can be exhibited to form a high density circuit pattern required for FPCBs to be miniaturized and have high performance in the future.

In addition, since the laminate for an FPCB of the present invention has a crystal particle size smaller than a conventional laminate for an FPCB, short circuit and wire breakage caused by metal fatigue due to many windings formed on the FPCB are not generated in a short time. Thus, the defect rates are lowered, and a highly reliable FPCB can be manufactured.

In addition, the tie layer of the present invention functions as a diffusion prevention film which prevents the copper particles from being diffused into the polyimide film, and therefore, the laminate for an FPCB of the present invention has high insulating properties to be suitable for use in circuit substrates. Consequently, the laminate for an FPCB having a tie layer of the present invention may be used as a circuit substrate which is normally operated without malfunction under stringent operation conditions of high accuracy and high frequencies.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A laminate for a flexible printed circuit board, comprising a base film, and a tie layer formed on the base film, in which the tie layer is formed of a copper alloy containing Zn—V or Zn—Ta.

2. The laminate as set forth in claim 1, wherein the tie layer is formed of a copper alloy containing Zn—V, in which a composition ratio of Zn in the copper alloy is larger than that of V.

3. The laminate as set forth in claim 2, wherein the Zn is contained in an amount more than 2.5% but not more than 5%, and the V is contained in an amount less than 2.5%.

4. The laminate as set forth in claim 1, wherein the tie layer is formed of a copper alloy containing Zn—Ta, in which a composition ratio of Zn in the copper alloy is larger than that of Ta.

5. The laminate as set forth in claim 4, wherein the Zn is contained in an amount more than 2.5% but not more than 5%, and the Ta is contained in an amount less than 2.5%.

6. The laminate as set forth in any one of claims 1 to 5, wherein the base film is a polyimide film.

7. The laminate as set forth in any one of claims 1 to 5, wherein the tie layer is formed by sputtering.
